(19) United States
(12) Patent Application Publication
(10) Pub. No.: US 2026/0002959 A1
(43) Pub. Date: Jan. 1, 2026

(54) ACCELERATION CALCULATION DEVICE

(71) Applicants: TOYOTA JIDOSHA KABUSHIKI KAISHA, Toyota-shi (JP); ADVICS CO., LTD., KARIYA-SHI AICHI-KEN (JP)

(72) Inventors: Nobuyuki ITOH, Toyota-shi (JP); Masayuki ASANO, Tokyo (JP)

(73) Assignees: TOYOTA JIDOSHA KABUSHIKI KAISHA, Toyota-shi (JP); ADVICS CO., LTD., KARIYA-SHI AICHI-KEN (JP)

(21) Appl. No.: 19/238,837

(22) Filed: Jun. 16, 2025

(30) Foreign Application Priority Data
Jun. 27, 2024 (JP) 2024-103779

(51) Int. Cl. G01P 21/00

(52) U.S. Cl. CPC G01P 21/00

(57) ABSTRACT

An acceleration calculation device calculates an estimated acceleration of a vehicle using a first acceleration and a second acceleration when both an acceleration sensor and a wheel speed sensor are normal. The acceleration calculation device calculates the estimated acceleration using only the first acceleration between the first acceleration and the second acceleration when the acceleration sensor is normal, and the wheel speed sensor is abnormal. The acceleration calculation device calculates the estimated acceleration using only the second acceleration between the first acceleration and the second acceleration when the acceleration sensor is abnormal, and the wheel speed sensor is normal.

### CROSS-REFERENCE TO RELATED APPLICATION

This application claims priority to Japanese Patent Application No. 2024-103779 filed on Jun. 27, 2024, incorporated herein by reference in its entirety.

### BACKGROUND

### 1. Technical Field

The present disclosure relates to an acceleration calculation device.

### 2. Description of Related Art

Japanese Unexamined Patent Application Publication No. 5-004575 (JP 5-004575 A) discloses a calculation device including first means for calculating an estimated vehicle body acceleration based on a wheel speed calculated from a wheel speed sensor, and second means for calculating an estimated acceleration calculated from an acceleration sensor. The calculation device selectively uses the first means and the second means depending on a traveling condition of a vehicle.

### SUMMARY

There is room for consideration as to a method for calculating an estimated acceleration of a vehicle when one of a wheel speed sensor and an acceleration sensor becomes abnormal.

An acceleration calculation device is an acceleration calculation device provided in a vehicle. The vehicle includes an acceleration sensor that detects a first acceleration that acts in a front-rear direction of the vehicle, and a plurality of wheel speed sensors each of which detects a wheel speed that is a rotation speed of a wheel provided in the vehicle. The acceleration calculation device acquires the first acceleration from the acceleration sensor. The acceleration calculation device calculates a second acceleration from a change rate of the wheel speed acquired from the plurality of wheel speed sensors. The acceleration calculation device calculates an estimated acceleration of the vehicle using the first acceleration and the second acceleration when both the acceleration sensor and the wheel speed sensors are normal, calculates the estimated acceleration using only the first acceleration between the first acceleration and the second acceleration when the acceleration sensor is normal, and the wheel speed sensors are abnormal, and calculates the estimated acceleration using only the second acceleration between the first acceleration and the second acceleration when the acceleration sensor is abnormal, and the wheel speed sensors are normal.

The acceleration calculation device can continue to calculate the estimated acceleration of the vehicle even when one of the acceleration sensor and the wheel speed sensors is abnormal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram illustrating a configuration of a dynamics manager of a vehicle according to one embodiment;

FIG. 2 is a functional block diagram illustrating calculation processing of an estimated acceleration to be executed by an acceleration calculation device of a first embodiment; and

FIG. 3 is a flowchart indicating flow of calculation processing of an estimated acceleration to be executed by an acceleration calculation device of a second embodiment.

### DETAILED DESCRIPTION OF EMBODIMENTS

### First Embodiment

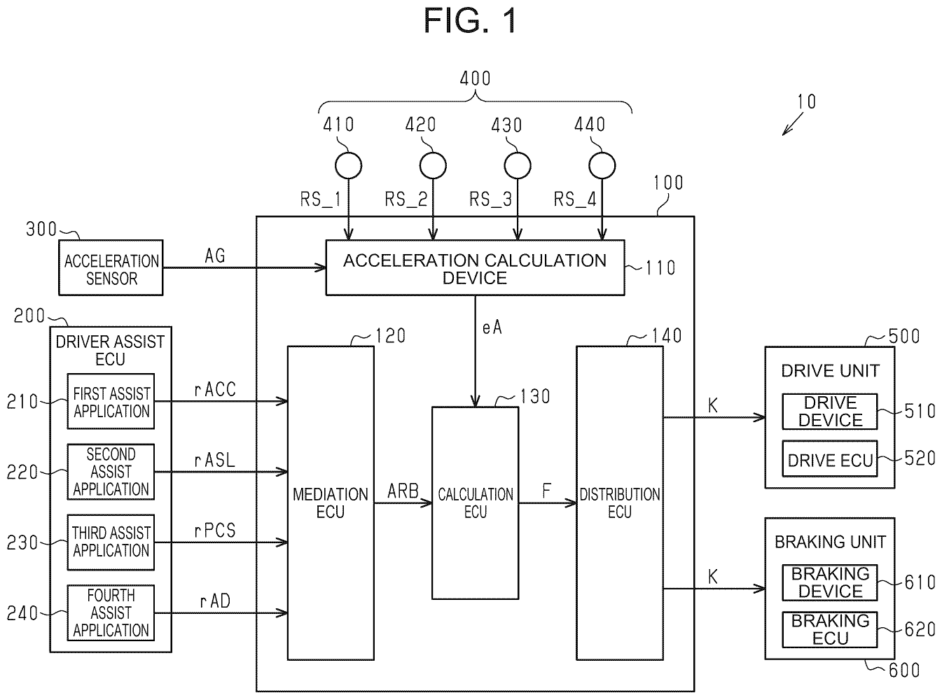

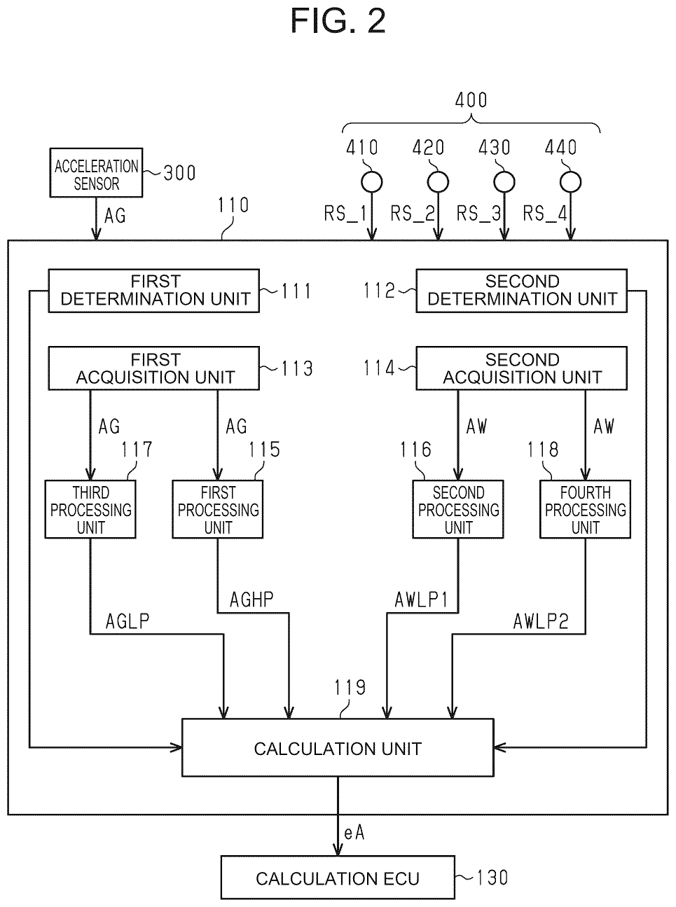

An acceleration calculation device 110 according to a first embodiment will be described below with reference to FIG. 1 and FIG. 2. In the following description, “front”, “rear”, “right” and “left” refer to “front”, “rear”, “right” and “left” seen from an occupant in a state where the occupant faces forward of a vehicle. A left-right direction coincides with a vehicle width direction.

### Overall Configuration of Vehicle 10

As illustrated in FIG. 1, a vehicle 10 includes a dynamics manager 100, a driver assist electronic control unit (ECU) 200, an acceleration sensor 300, a plurality of wheel speed sensors 400, a drive unit 500, and a braking unit 600. The ECU includes a CPU, and a memory in which programs for control and data are stored. The ECU executes processing regarding various kinds of control by the CPU executing the programs stored in the memory.

### Dynamics Manager 100

The dynamics manager 100 comprehensively controls the whole of the vehicle 10. The dynamics manager 100 is constituted with a processing circuit. For example, the processing circuit includes an execution device and a storage device. The storage device stores various kinds of control programs to be executed by the execution device. The processing circuit implements various kinds of processing by the execution device executing the control programs. The dynamics manager 100 is configured to be able to perform communication with each other with the driver assist ECU 200. The dynamics manager 100 is configured to be able to perform communication with each other with the acceleration sensor 300 and the plurality of wheel speed sensors 400. The dynamics manager 100 is configured to be able to perform communication with each other with the drive unit 500 and the braking unit 600. A configuration of the dynamics manager 100 will be described later.

### Driver Assist ECU 200

The driver assist ECU 200 implements functions regarding driver assist of the vehicle 10. The driver assist ECU 200 is constituted with a processing circuit. The driver assist ECU 200 stores a plurality of applications. Each application stored in the driver assist ECU 200 outputs a dynamics request to the dynamics manager 100. The applications stored in the driver assist ECU 200 include a first assist application 210, a second assist application 220, a third assist application 230, and a fourth assist application 240.

The first assist application 210 is application software that implements adaptive cruise control (ACC) that causes the vehicle 10 to execute following traveling while keeping a constant inter-vehicle distance with a preceding vehicle that travels ahead of the vehicle 10 as a function regarding driver assist. The first assist application 210 outputs a required acceleration rACC that is an acceleration of the vehicle 10 necessary for implementing the ACC to the dynamics manager 100 as the dynamics request.

The second assist application 220 is application software that implements auto speed limiter (ASL) that limits an upper limit of a speed of the vehicle 10 in accordance with a speed displayed on a road sign as a function regarding driver assist. The second assist application 220 outputs a required acceleration rASL that is an acceleration of the vehicle 10 necessary for implementing the ASL to the dynamics manager 100 as the dynamics request.

The third assist application 230 is application software that implements pre-crash safety (PCS) that performs warning to a driver of the vehicle 10 or emergency braking of the vehicle 10 when there is a possibility that the vehicle 10 may collide with a preceding vehicle as a function regarding driver assist. The third assist application 230 outputs a required acceleration rPCS that is an acceleration of the vehicle 10 necessary for implementing the PCS to the dynamics manager 100 as the dynamics request.

The fourth assist application 240 is application software that implements autonomous driving function of causing the vehicle 10 to autonomously traveling without operation by a driver as a function regarding driver assist. The fourth assist application 240 outputs a required acceleration rAD that is an acceleration of the vehicle 10 necessary for implementing the autonomous driving function to the dynamics manager 100 as the dynamics request.

### Acceleration Sensor 300 and Wheel Speed Sensor 400

The acceleration sensor 300 is configured to be able to detect a first acceleration AG that acts in a front-rear direction of the vehicle 10. The acceleration sensor 300 outputs the detected first acceleration AG to the dynamics manager 100.

Each of the plurality of wheel speed sensors 400 is configured to be able to detect a wheel speed RS that is a rotation speed of a wheel provided in the vehicle 10. The vehicle 10 includes a first wheel speed sensor 410, a second wheel speed sensor 420, a third wheel speed sensor 430, and a fourth wheel speed sensor 440 as the plurality of wheel speed sensors 400. The first wheel speed sensor 410 detects a first wheel speed RS_1 that is the wheel speed RS of a right front wheel of the vehicle 10. The first wheel speed sensor 410 outputs the first wheel speed RS_1 to the dynamics manager 100. The second wheel speed sensor 420 detects a second wheel speed RS_2 that is the wheel speed RS of a left front wheel of the vehicle 10. The second wheel speed sensor 420 outputs the second wheel speed RS_2 to the dynamics manager 100. The third wheel speed sensor 430 detects a third wheel speed RS_3 that is the wheel speed of a right rear wheel of the vehicle 10. The third wheel speed sensor 430 outputs the third wheel speed RS_3 to the dynamics manager 100. The fourth wheel speed sensor 440 detects a fourth wheel speed RS_4 that is the wheel speed RS of a left rear wheel of the vehicle 10. The fourth wheel speed sensor 440 outputs the fourth wheel speed RS_4 to the dynamics manager 100.

### Drive Unit 500 and Braking Unit 600

The drive unit 500 and the braking unit 600 are actuators of the vehicle 10. The drive unit 500 includes a drive device 510 of the vehicle 10 and a drive ECU 520. The drive device 510 of the vehicle 10 is, for example, an engine. The drive device 510 of the vehicle 10 may be a motor generator. The drive ECU 520 is a processing circuit that is targeted at controlling the drive device 510. The drive ECU 520 controls the drive device 510 of the vehicle 10 in accordance with instruction information K input from the dynamics manager 100.

The braking unit 600 includes a braking device 610 for each wheel, and a braking ECU 620. The braking device 610 is, for example, a disk brake. The braking ECU 620 is a processing circuit that is targeted at controlling each braking device 610. The braking ECU 620 controls each braking device 610 in accordance with the instruction information K input from the dynamics manager 100.

### Configuration of Dynamics Manager 100

The dynamics manager 100 accepts a plurality of dynamics requests from the driver assist ECU 200. The dynamics manager 100 controls the vehicle 10 by mediating the plurality of dynamics requests. The dynamics manager 100 includes an acceleration calculation device 110, a mediation ECU 120, a calculation ECU 130, and a distribution ECU 140.

The acceleration calculation device 110 calculates an estimated acceleration eA of the vehicle 10 based on the first acceleration AG or the wheel speed RS. Calculation processing of the estimated acceleration eA to be executed by the acceleration calculation device 110 will be described later. The acceleration calculation device 110 outputs the estimated acceleration eA to the calculation ECU 130.

The mediation ECU 120 mediates a plurality of dynamics requests. The plurality of dynamics requests includes the required acceleration rACC, the required acceleration rASL, the required acceleration rPCS, and the required acceleration rAD input from the driver assist ECU 200. When only one dynamics request is input from the driver assist ECU 200, the mediation ECU 120 outputs the required acceleration rA in the dynamics request to the calculation ECU 130 as a mediation result ARB. For example, when only the required acceleration rACC is input from the first assist application 210 as the dynamics request input to the mediation ECU 120, the mediation ECU 120 outputs the required acceleration rACC to the calculation ECU 130 as the mediation result ARB. When a plurality of dynamics requests is input from the driver assist ECU 200, the mediation ECU 120 selects a dynamics request having a smaller required acceleration rA as the mediation result ARB. For example, when the plurality of required accelerations rA that are the dynamics requests are all negative values, the mediation ECU 120 selects a dynamics request with a large absolute value as the mediation result ARB. By this means, the mediation ECU 120 mediates the plurality of dynamics requests. For example, when the required acceleration rASL is smaller than the required acceleration rACC, the mediation ECU 120 selects the required acceleration rASL as the mediation result ARB. The mediation method to be executed by the mediation ECU 120 is not limited to the above-described examples. It is only necessary that mediation rules are determined such that the mediation ECU 120 can obtain an appropriate mediation result ARB. The mediation ECU 120 outputs the required acceleration rASL that is the mediation result ARB to the calculation ECU 130.

The calculation ECU 130 receives input of the estimated acceleration eA from the acceleration calculation device 110. The calculation ECU 130 receives input of the mediation result ARB from the mediation ECU 120. The calculation ECU 130 calculates a necessary acceleration F that is an acceleration necessary for making the acceleration of the vehicle 10 the required acceleration rA. For example, the calculation ECU 130 calculates the necessary acceleration F based on a difference between the estimated acceleration eA and the mediation result ARB. The calculation method of the necessary acceleration F to be executed by the calculation ECU 130 is not limited to the above-described example. It is only necessary that rules of the calculation method are determined such that the calculation ECU 130 can obtain an appropriate necessary acceleration F. The calculation ECU 130 outputs the necessary acceleration F to the distribution ECU 140. When the estimated acceleration eA is not input from the acceleration calculation device 110, the calculation ECU 130 does not execute calculation of the necessary acceleration F and output of the necessary acceleration F to the distribution ECU 140.

The distribution ECU 140 controls the drive unit 500 and the braking unit 600 based on the necessary acceleration F input from the calculation ECU 130. In other words, the distribution ECU 140 outputs the instruction information K necessary for the vehicle 10 to implement the necessary acceleration F to each actuator. By this means, the vehicle 10 executes the functions regarding driver assist of the vehicle 10 instructed by the driver assist ECU 200. When the necessary acceleration F is not input from the calculation ECU 130, the distribution ECU 140 does not output the instruction information K to each actuator. In other words, when the estimated acceleration eA is not input to the mediation ECU 120 from the acceleration calculation device 110, the vehicle 10 does not execute the functions regarding driver assist.

### Calculation Processing of Estimated Acceleration eA to be Executed by Acceleration Calculation Device 110

FIG. 2 is a functional block diagram illustrating calculation processing of the estimated acceleration eA to be executed by the acceleration calculation device 110 in the first embodiment. As illustrated in FIG. 2, the acceleration calculation device 110 includes a first determination unit 111, a second determination unit 112, a first acquisition unit 113, a second acquisition unit 114, a first processing unit 115, a second processing unit 116, a third processing unit 117, a fourth processing unit 118, and a calculation unit 119.

The first determination unit 111 determines whether or not there is an abnormality in the acceleration sensor 300. The first determination unit 111 determines that there is an abnormality in the acceleration sensor 300 when a change rate of the first acceleration AG input to the acceleration calculation device 110 exceeds a predetermined threshold. For example, when the first acceleration AG is not input to the acceleration calculation device 110, the first determination unit 111 determines that there is an abnormality in the acceleration sensor 300. The first determination unit 111 outputs the determination result to the calculation unit 119.

The second determination unit 112 determines whether or not there is an abnormality in each wheel speed sensor 400. For example, when a change rate of the first wheel speed RS_1 exceeds a predetermined threshold, the second determination unit 112 determines that there is an abnormality in the first wheel speed sensor 410. For example, when the first wheel speed RS_1 is not input to the acceleration calculation device 110, the second determination unit 112 determines that there is an abnormality in the first wheel speed sensor 410. The second determination unit 112 also determines whether or not there is an abnormality in other wheel speed sensors 400 in a similar manner. When there is an abnormality in at least one of the first wheel speed sensor 410, the second wheel speed sensor 420, the third wheel speed sensor 430, or the fourth wheel speed sensor 440, the acceleration calculation device 110 determines that there is an abnormality in the wheel speed sensor 400. The second determination unit 112 outputs the determination result to the calculation unit 119.

The first acquisition unit 113 acquires the first acceleration AG from the acceleration sensor 300. The first acquisition unit 113 outputs the first acceleration AG to the first processing unit 115 and the third processing unit 117.

The second acquisition unit 114 acquires the first wheel speed RS_1, the second wheel speed RS_2, the third wheel speed RS_3, and the fourth wheel speed RS_4. The second acquisition unit 114 selects a wheel speed RS for calculating the second acceleration AW from the plurality of wheel speeds RS. The second acquisition unit 114 calculates the second acceleration AW based on the selected wheel speed RS.

For example, the second acquisition unit 114 selects the second highest wheel speed RS among the four wheel speeds RS as the wheel speed RS for calculating the second acceleration AW. When the second highest wheel speed RS is the second wheel speed RS_2, the second acquisition unit 114 calculates the second acceleration AW based on a change rate of the second wheel speed RS_2. For example, the second acquisition unit 114 selects the highest wheel speed RS among the wheel speeds RS of drive wheels as the wheel speed RS for calculating the second acceleration AW. When the right front wheel and the left front wheel are drive wheels, and the first wheel speed RS_1 that is the wheel speed RS of the right front wheel is higher than the second wheel speed RS_2 that is the wheel speed RS of the left front wheel, the second acquisition unit 114 calculates the second acceleration AW based on a change rate of the first wheel speed RS_1. The selection method of the wheel speed RS to be executed by the second acquisition unit 114 is not limited to the above-described examples. It is only necessary that rules of the selection method of the wheel speed RS are determined such that the second acquisition unit 114 can obtain an appropriate second acceleration AW.

The second acquisition unit 114 outputs the second acceleration AW to the second processing unit 116 and the fourth processing unit 118.

The first processing unit 115 receives input of the first acceleration AG from the first acquisition unit 113. The first processing unit 115 executes first processing of applying high-pass filter HPF processing to the first acceleration AG. As a result of this, the first processing unit 115 acquires the first acceleration subjected to the first processing AGHP. The first processing unit 115 outputs the first acceleration subjected to the first processing AGHP to the calculation unit 119.

The second processing unit 116 receives input of the second acceleration AW from the second acquisition unit 114. The second processing unit 116 executes second processing of applying first low-pass filter LPF_1 processing to the second acceleration AW. As a result of this, the second processing unit 116 acquires the second acceleration subjected to the second processing AWLP1. The second processing unit 116 outputs the second acceleration subjected to the second processing AWLP1 to the calculation unit 119. A cutoff frequency fc in the high-pass filter HPF processing to be executed by the first processing unit 115 is equal to a cutoff frequency fc in the first low-pass filter LPF_1 processing to be executed by the second processing unit 116.

The third processing unit 117 receives input of the first acceleration AG from the first acquisition unit 113. The third processing unit 117 executes third processing of applying low-pass filter LPF processing to the first acceleration AG. As a result of this, the third processing unit 117 acquires the first acceleration subjected to the third processing AGLP. The third processing unit 117 outputs the first acceleration subjected to the third processing AGLP to the calculation unit 119.

The fourth processing unit 118 receives input of the second acceleration AW from the second acquisition unit 114. The fourth processing unit 118 executes fourth processing of applying to the second acceleration AW, second low-pass filter LPF_2 processing in which the cutoff frequency fc is lower than the cutoff frequency fc in the first low-pass filter LPF_1 processing. As a result of this, the fourth processing unit 118 acquires the second acceleration subjected to the fourth processing AWLP2. The fourth processing unit 118 outputs the second acceleration subjected to the fourth processing AWLP2 to the calculation unit 119.

In the first embodiment, the acceleration calculation device 110 repeatedly executes the first processing, the second processing, the third processing, and the fourth processing with a predetermined period regardless of whether or not there is an abnormality in the acceleration sensor 300 and whether or not there is an abnormality in the wheel speed sensor 400.

The calculation unit 119 receives input of the determination result as to whether or not there is an abnormality in the acceleration sensor 300 from the first determination unit 111. The calculation unit 119 receives input of the determination result as to whether or not there is an abnormality in the wheel speed sensor 400 from the second determination unit 112. The calculation unit 119 receives input of the first acceleration subjected to the first processing AGHP from the first processing unit 115. The calculation unit 119 receives input of the second acceleration subjected to the second processing AWLP1 from the second processing unit 116. The calculation unit 119 receives input of the first acceleration subjected to the third processing AGLP from the third processing unit 117. The calculation unit 119 receives input of the second acceleration subjected to the fourth processing AWLP2 from the fourth processing unit 118.

When both the acceleration sensor 300 and the wheel speed sensor 400 are normal, the calculation unit 119 acquires a superimposed acceleration AGHP+AWLP1 by adding the first acceleration subjected to the first processing AGHP and the second acceleration subjected to the second processing AWLP1. A cutoff frequency fc in the high-pass filter HPF processing is equal to a cutoff frequency fc in the first low-pass filter LPF_1 processing. Then, the acceleration calculation device 110 applies third low-pass filter LPF_3 processing to the superimposed acceleration AGHP+AWLP1. As a result of this, the acceleration calculation device 110 acquires the processed superimposed acceleration AGHP+AWLP1_LP3. Then, the acceleration calculation device 110 outputs the processed superimposed acceleration AGHP+AWLP1_LP3 as the estimated acceleration eA of the vehicle 10.

When the acceleration sensor 300 is normal, and the wheel speed sensor 400 is abnormal, the calculation unit 119 outputs the first acceleration subjected to the third processing AGLP as the estimated acceleration eA.

When the acceleration sensor 300 is abnormal, and the wheel speed sensor 400 is normal, the calculation unit 119 outputs the second acceleration subjected to the fourth processing AWLP2 as the estimated acceleration eA.

When both the acceleration sensor 300 and the wheel speed sensor 400 are abnormal, the calculation unit 119 does not calculate the estimated acceleration eA. The calculation unit 119 outputs the estimated acceleration eA to the calculation ECU 130. When the calculation unit 119 does not calculate the estimated acceleration eA, the calculation unit 119 does not output a signal to the calculation ECU 130.

### Operation of First Embodiment

The acceleration calculation device 110 calculates the estimated acceleration eA using the first acceleration AG when the acceleration sensor 300 is not abnormal even when the wheel speed sensor 400 is abnormal. The acceleration calculation device 110 calculates the estimated acceleration eA using the second acceleration AW when the wheel speed sensor 400 is not abnormal even when the acceleration sensor 300 is abnormal.

### Effects of First Embodiment

(1-1) The acceleration calculation device 110 can continue to calculate the estimated acceleration eA of the vehicle 10 even when one of the acceleration sensor 300 and the wheel speed sensor 400 is abnormal.
(1-2) The first acceleration AG acquired by the first processing unit 115 from the acceleration sensor 300 is likely to include noise components in a low frequency due to a gradient of a road surface, an inclination of the acceleration sensor 300, and the like. The second acceleration AW calculated by the second processing unit 116 from the change rate of the wheel speed RS is likely to include noise components in a high frequency due to influence of a step of a road surface, a joint of road surfaces, and the like.

When both the acceleration sensor 300 and the wheel speed sensor 400 are normal, the acceleration calculation device 110 calculates the estimated acceleration eA of the vehicle 10 based on the first acceleration subjected to the first processing AGHP and the second acceleration subjected to the second processing AWLP1. The first acceleration subjected to the first processing AGHP is the first acceleration AG obtained by reducing the noise components in a low frequency by the high-pass filter HPF processing. The second acceleration subjected to the second processing AWLP1 is the second acceleration AW obtained by reducing the noise components in a high frequency by the first low-pass filter LPF_1 processing. Thus, the acceleration calculation device 110 can calculate a more appropriate estimated acceleration eA with less noise components when both the acceleration sensor 300 and the wheel speed sensor 400 are normal.
(1-3) There is a possibility that the first processing may remove also acceleration components in a low frequency along with the noise components in a low frequency from the first acceleration AG. When the acceleration sensor 300 is normal, and the wheel speed sensor 400 is abnormal, the acceleration calculation device 110 executes the third processing of applying the low-pass filter LPF processing to the first acceleration AG. The first acceleration subjected to the third processing AGLP includes the acceleration components in a low frequency in the first acceleration AG. The acceleration calculation device 110 can continue to output the estimated acceleration eA including the acceleration components in a low frequency even when the acceleration sensor 300 is normal, and the wheel speed sensor 400 is abnormal.
(1-4) Influence of noise components originating from the second acceleration subjected to the second processing AWLP1 is greater in the second acceleration subjected to the second processing AWLP1 than the estimated acceleration eA calculated based on the first acceleration subjected to the first processing AGHP and the second acceleration subjected to the second processing AWLP1. When the cutoff frequency fc in the low-pass filter processing is made lower, noise components in a wider frequency band can be removed from the second acceleration AW. Thus, the second acceleration subjected to the fourth processing AWLP2 to which the second low-pass filter LPF_2 processing in which the cutoff frequency fc is smaller than the cutoff frequency in the first low-pass filter LPF_1 processing is applied, has less noise components than the second acceleration subjected to the second processing AWLP1. When the acceleration sensor 300 is abnormal, and the wheel speed sensor 400 is normal, the acceleration calculation device 110 can continue to output a more appropriate estimated acceleration eA by reducing the noise components included in the second acceleration AW to be used for calculation of the estimated acceleration eA.
(1-5) The acceleration calculation device 110 executes all of the first processing, the second processing, the third processing, and the fourth processing regardless of whether or not there is an abnormality in the acceleration sensor 300 and whether or not there is an abnormality in the wheel speed sensor 400. As a result of this, when an abnormality occurs in one of the acceleration sensor 300 and the wheel speed sensor 400, the acceleration calculation device 110 can immediately calculate the estimated acceleration eA of the vehicle 10 based on output of the sensor in which an abnormality does not occur.
(1-6) When both the acceleration sensor 300 and the wheel speed sensor 400 are abnormal, the acceleration calculation device 110 does not calculate the estimated acceleration eA. When both the acceleration sensor 300 and the wheel speed sensor 400 are abnormal, both the first acceleration AG and the second acceleration AW necessary for the acceleration calculation device 110 to calculate the estimated acceleration eA become inaccurate numerical values. When both the first acceleration AG and the second acceleration AW are inaccurate numerical values, the estimated acceleration eA calculated by the acceleration calculation device 110 based on the first acceleration AG or the second acceleration AW also becomes an inaccurate numerical value. Thus, when both the acceleration sensor 300 and the wheel speed sensor 400 are abnormal, the acceleration calculation device 110 does not calculate the estimated acceleration eA. As a result of this, the acceleration calculation device 110 can avoid calculation of an inaccurate estimated acceleration eA.
(1-7) When an abnormality occurs in one or more wheel speed sensors 400 among the plurality of wheel speed sensors 400, there is a possibility that an inappropriate second acceleration AW may be calculated. The acceleration calculation device 110 determines that an abnormality occurs in the wheel speed sensor 400 when an abnormality occurs in one or more wheel speed sensors 400. When the acceleration calculation device 110 determines that an abnormality occurs in the wheel speed sensor 400, the acceleration calculation device 110 calculates the estimated acceleration eA only using the first acceleration AG between the first acceleration AG and the second acceleration AW. As a result of this, the acceleration calculation device 110 can calculate the estimated acceleration eA of the vehicle 10 without using the inappropriate second acceleration AW.

### Second Embodiment

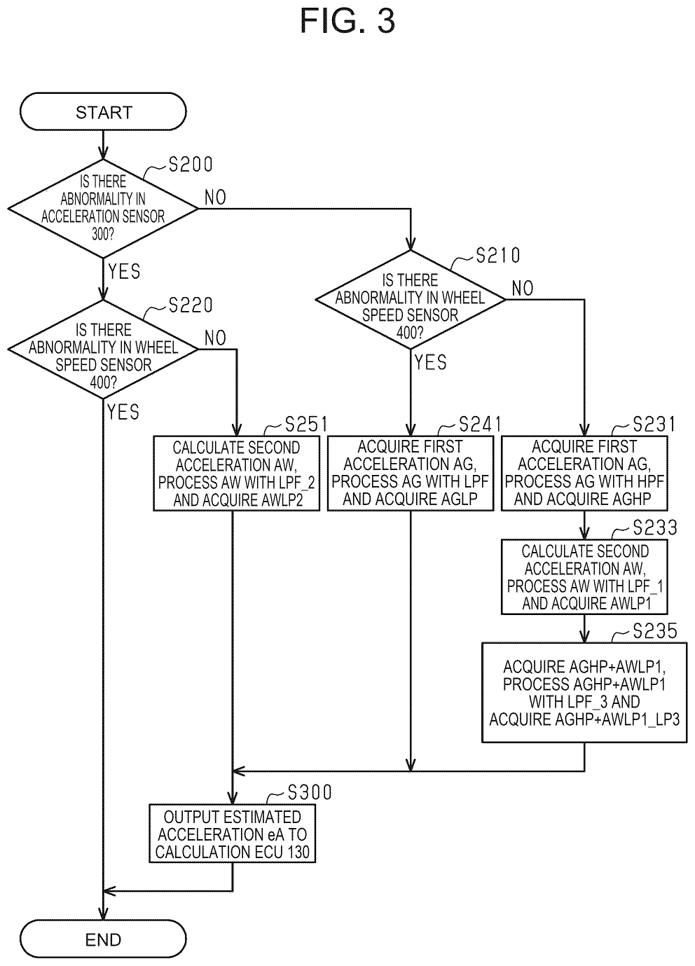

The acceleration calculation device 110 according to a second embodiment will be described with reference to FIG. 3. Concerning the second embodiment, differences from the first embodiment will be mainly described.

FIG. 3 is a flowchart indicating flow of the acceleration calculation device 110 according to the second embodiment calculating the estimated acceleration eA. The acceleration calculation device 110 repeatedly calculates the estimated acceleration eA with a predetermined period.

As illustrated in FIG. 3, when the series of processing is started, the acceleration calculation device 110 acquires whether or not there is an abnormality in the acceleration sensor 300 in step S200. When the acceleration calculation device 110 determines that there is no abnormality in the acceleration sensor 300 in the processing in step S200 (step S200: No), that is, when the acceleration sensor 300 is normal, the processing proceeds to step S210.

### When Both Acceleration Sensor 300 and Wheel Speed Sensor 400 are Normal

In step S210, the acceleration calculation device 110 acquires whether or not there is an abnormality in the wheel speed sensor 400. When the acceleration calculation device 110 determines that the wheel speed sensor 400 is not abnormal in step S210 (step S210: No), that is, when both the acceleration sensor 300 and the wheel speed sensor 400 are normal, the processing proceeds to step S231.

In step S231, the acceleration calculation device 110 acquires the first acceleration AG from the acceleration sensor 300. Then, the acceleration calculation device 110 executes the first processing of applying the high-pass filter HPF processing to the first acceleration AG. As a result of this, the acceleration calculation device 110 acquires the first acceleration subjected to the first processing AGHP. Then, the processing proceeds to step S233.

In step S233, the acceleration calculation device 110 selects the wheel speed RS for calculating the second acceleration AW, from a plurality of wheel speeds RS. The acceleration calculation device 110 calculates the second acceleration AW based on the selected wheel speed RS.

For example, the acceleration calculation device 110 selects the second highest wheel speed RS among the four wheel speeds RS as the wheel speed RS for calculating the second acceleration AW. When the second highest wheel speed RS is the second wheel speed RS_2, the acceleration calculation device 110 calculates the second acceleration AW based on a change rate of the second wheel speed RS_2. For example, the acceleration calculation device 110 selects the highest wheel speed RS among the wheel speeds RS of the drive wheels as the wheel speed RS for calculating the second acceleration AW. When the right front wheel and the left front wheel are drive wheels, and the first wheel speed RS_1 that is the wheel speed RS of the right front wheel is higher than the second wheel speed RS_2 that is the wheel speed RS of the left front wheel, the acceleration calculation device 110 calculates the second acceleration AW based on a change rate of the first wheel speed RS_1. The selection method of the wheel speed RS to be executed by the acceleration calculation device 110 is not limited to the above-described examples. It is only necessary that rules of the selection method of the wheel speed RS are determined such that the acceleration calculation device 110 can obtain an appropriate second acceleration AW.

After the acceleration calculation device 110 calculates the second acceleration AW, the acceleration calculation device 110 executes the second processing of applying the first low-pass filter LPF_1 processing to the second acceleration AW. As a result of this, the acceleration calculation device 110 acquires the second acceleration subjected to the second processing AWLP1. A cutoff frequency fc in the high-pass filter processing is equal to a cutoff frequency fc in the first low-pass filter LPF_1 processing. Then, the processing proceeds to step S235.

In step S235, the acceleration calculation device 110 acquires a superimposed acceleration AGHP+AWLP1 by adding the first acceleration subjected to the first processing AGHP and the second acceleration subjected to the second processing AWLP1. Then, the acceleration calculation device 110 applies the third low-pass filter LPF_3 processing to the superimposed acceleration AGHP+AWLP1. As a result of this, the acceleration calculation device 110 acquires the processed superimposed acceleration AGHP+AWLP1_LP3. Then, the acceleration calculation device 110 outputs the processed superimposed acceleration AGHP+AWLP1_LP3 as the estimated acceleration eA of the vehicle 10. Then, the processing proceeds to step S300.

In step S300, the acceleration calculation device 110 outputs the estimated acceleration eA to the calculation ECU 130. Then, the series of processing ends.

### When Acceleration Sensor 300 is Normal and Wheel Speed Sensor 400 is Abnormal

When there is an abnormality in the wheel speed sensor 400 in step S210 (step S210: Yes), that is, when the acceleration sensor 300 is normal, and the wheel speed sensor 400 is abnormal, the processing proceeds to step S241.

In step S241, the acceleration calculation device 110 acquires the first acceleration AG from the acceleration sensor 300. Then, the acceleration calculation device 110 executes the third processing of applying the low-pass filter LPF processing to the first acceleration AG. As a result of this, the acceleration calculation device 110 acquires the first acceleration subjected to the third processing AGLP. Then, the acceleration calculation device 110 outputs the first acceleration subjected to the third processing AGLP as the estimated acceleration eA of the vehicle 10. Then, the processing proceeds to step S300.

In step S300, the acceleration calculation device 110 outputs the estimated acceleration eA to the calculation ECU 130. Then, the acceleration calculation device 110 ends the series of processing.

### When Acceleration Sensor 300 is Abnormal and Wheel Speed Sensor 400 is Normal

When there is an abnormality in the acceleration sensor 300 in step S200 (step S200: Yes), the processing proceeds to step S220.

When there is no abnormality in the wheel speed sensor 400 in step S220 (step S220: No), that is, when the acceleration sensor 300 is abnormal, and the wheel speed sensor 400 is normal, the processing proceeds to step S251.

In step S251, the acceleration calculation device 110 selects the wheel speed RS for calculating the second acceleration AW, from the plurality of wheel speeds RS in a similar manner to step S233. The acceleration calculation device 110 calculates the second acceleration AW based on the selected wheel speed RS in a similar manner to step S233. Then, the acceleration calculation device 110 executes the fourth processing of applying the second low-pass filter LPF_2 processing to the second acceleration AW. As a result of this, the acceleration calculation device 110 acquires the second acceleration subjected to the fourth processing AWLP2. A cutoff frequency fc of the second low-pass filter LPF_2 is lower than a cutoff frequency fc of the first low-pass filter LPF_1. The acceleration calculation device 110 outputs the second acceleration subjected to the fourth processing AWLP2 as the estimated acceleration eA of the vehicle 10. Then, the processing proceeds to step S300.

In step S300, the acceleration calculation device 110 outputs the estimated acceleration eA to the calculation ECU 130. Then, the acceleration calculation device 110 ends the series of processing.

### When Both Acceleration Sensor 300 and Wheel Speed Sensor 400 are Abnormal

When there is an abnormality in the wheel speed sensor 400 in step S220 (step S220: Yes), that is, when both the acceleration sensor 300 and the wheel speed sensor 400 are abnormal, the acceleration calculation device 110 ends the series of processing without calculating the estimated acceleration eA.

### Operation of Second Embodiment

When both the acceleration sensor 300 and the wheel speed sensor 400 are normal (S210: No), the acceleration calculation device 110 calculates the estimated acceleration eA of the vehicle 10 using the first acceleration AG and the second acceleration AW. When the acceleration sensor 300 is normal, and the wheel speed sensor 400 is abnormal (S210: Yes), the acceleration calculation device 110 calculates the estimated acceleration eA using only the first acceleration AG between the first acceleration AG and the second acceleration AW. When the acceleration sensor 300 is abnormal, and the wheel speed sensor 400 is normal (S220: No), the acceleration calculation device 110 calculates the estimated acceleration eA using only the second acceleration AW between the first acceleration AG and the second acceleration AW. When both the acceleration sensor 300 and the wheel speed sensor 400 are abnormal (S220: Yes), the acceleration calculation device 110 does not calculate the estimated acceleration eA of the vehicle 10.

### Effects of Second Embodiment

(2-1) The acceleration calculation device 110 changes processing of calculating the estimated acceleration eA in accordance with whether or not there is an abnormality in the acceleration sensor 300 and the wheel speed sensor 400. This enables the acceleration calculation device 110 to reduce load on the processing circuit for calculating the estimated acceleration eA.

### Modifications

Elements that can be commonly changed in the above-described embodiments are as follows. The following modifications can be combined with each other and implemented unless technical inconsistencies arise.

The acceleration calculation device 110 may change criteria for determining that there is an abnormality in the wheel speed sensor 400 if the estimated acceleration eA can be appropriately calculated. For example, the acceleration calculation device 110 may determine that there is an abnormality in the wheel speed sensor 400 when there are abnormalities in two or more sensors among the first wheel speed sensor 410, the second wheel speed sensor 420, the third wheel speed sensor 430, and the fourth wheel speed sensor 440. For example, the acceleration calculation device 110 may determine that there is an abnormality in the wheel speed sensor 400 when there are abnormalities in three or more sensors among the first wheel speed sensor 410, the second wheel speed sensor 420, the third wheel speed sensor 430, and the fourth wheel speed sensor 440. The acceleration calculation device 110 may determine that there is an abnormality in the wheel speed sensor 400 when there is an abnormality in the wheel speed sensor 400 provided in the drive wheel. For example, when the right front wheel and the left front wheel are drive wheels, the acceleration calculation device 110 may determine that there is an abnormality in the wheel speed sensor 400 when there is an abnormality in one of the first wheel speed sensor 410 and the second wheel speed sensor 420 provided in the drive wheels.

What is claimed is:

1. An acceleration calculation device of a vehicle,
the vehicle including:
an acceleration sensor that detects a first acceleration that acts in a front-rear direction of the vehicle; and
a plurality of wheel speed sensors each of which detects a wheel speed that is a rotation speed of a wheel provided in the vehicle,
the acceleration calculation device acquiring the first acceleration from the acceleration sensor,
calculating a second acceleration from a change rate of the wheel speed acquired from the plurality of wheel speed sensors,
calculating an estimated acceleration of the vehicle using the first acceleration and the second acceleration when both the acceleration sensor and the wheel speed sensors are normal,
calculating the estimated acceleration using only the first acceleration between the first acceleration and the second acceleration when the acceleration sensor is normal, and the wheel speed sensors are abnormal, and
calculating the estimated acceleration using only the second acceleration between the first acceleration and the second acceleration when the acceleration sensor is abnormal, and the wheel speed sensors are normal.

2. The acceleration calculation device according to claim 1, wherein:
when both the acceleration sensor and the wheel speed sensors are normal, the acceleration calculation device executes first processing of applying high-pass filter processing to the first acceleration to acquire the first acceleration subjected to the first processing and second processing of applying first low-pass filter processing to the second acceleration to acquire the second acceleration subjected to the second processing and calculates the estimated acceleration based on the first acceleration subjected to the first processing and the second acceleration subjected to the second processing;
when the acceleration sensor is normal, and the wheel speed sensors are abnormal, the acceleration calculation device executes third processing of applying low-pass filter processing to the first acceleration to acquire the first acceleration subjected to the third processing and outputs the first acceleration subjected to the third processing as the estimated acceleration; and
when the acceleration sensor is abnormal, and the wheel speed sensors are normal, the acceleration calculation device executes fourth processing of applying to the second acceleration, second low-pass filter processing in which a cutoff frequency is lower than a cutoff frequency in the first low-pass filter processing to acquire the second acceleration subjected to the fourth processing and outputs the second acceleration subjected to the fourth processing as the estimated acceleration.

3. The acceleration calculation device according to claim 1, wherein:
regardless of whether or not there is an abnormality in the acceleration sensor and whether or not there is an abnormality in the wheel speed sensors,
the acceleration calculation device executes all of:
first processing of applying high-pass filter processing to the first acceleration to acquire the first acceleration subjected to the first processing;
second processing of applying first low-pass filter processing to the second acceleration to acquire the second acceleration subjected to the second processing;
third processing of applying low-pass filter processing to the first acceleration to acquire the first acceleration subjected to the third processing; and
fourth processing of applying to the second acceleration, second low-pass filter processing in which a cutoff frequency is lower than a cutoff frequency in the first low-pass filter processing to acquire the second acceleration subjected to the fourth processing;
calculates the estimated acceleration based on the first acceleration subjected to the first processing and the second acceleration subjected to the second processing when both the acceleration sensor and the wheel speed sensors are normal;
outputs the first acceleration subjected to the third processing as the estimated acceleration when the acceleration sensor is normal, and the wheel speed sensors are abnormal; and
outputs the second acceleration subjected to the fourth processing as the estimated acceleration when the acceleration sensor is abnormal, and the wheel speed sensors are normal.

4. The acceleration calculation device according to claim 1, wherein the acceleration calculation device does not calculate the estimated acceleration when both the acceleration sensor and the wheel speed sensors are abnormal.

5. The acceleration calculation device according to claim 4, wherein:
the vehicle includes as the plurality of wheel speed sensors:
a first wheel speed sensor that acquires a rotation speed of a right front wheel of the vehicle;
a second wheel speed sensor that acquires a rotation speed of a left front wheel of the vehicle;
a third wheel speed sensor that acquires a rotation speed of a right rear wheel of the vehicle; and
a fourth wheel speed sensor that acquires a rotation speed of a left rear wheel of the vehicle; and
the acceleration calculation device determines that there is an abnormality in the wheel speed sensors when there is an abnormality in at least one of the first wheel speed sensor, the second wheel speed sensor, the third wheel speed sensor, or the fourth wheel speed sensor.
